(19) United States
(12) Patent Application Publication
(10) Pub. No.: US 2012/0158956 A1
(43) Pub. Date: Jun. 21, 2012

(54) INFORMATION PROCESSING APPARATUS, CONTROL METHOD THEREOF AND PROGRAM

(75) Inventor: Ritsuto Sako, Kawasaki-shi (JP)

(73) Assignee: CANON KABUSHIKI KAISHA, Tokyo (JP)

(21) Appl. No.: 13/312,439

(22) Filed: Dec. 6, 2011

(30) Foreign Application Priority Data
Dec. 15, 2010 (JP) 2010-279872

(51) Int. Cl. G06F 11/00

(52) U.S. Cl. 709/224

(57) ABSTRACT

The present invention provides an information processing apparatus that, when a particular event that is different from an operation event made on an operation screen provided by a web server has occurred, actively transmits a notification of the event to the web server and a control method thereof. To accomplish this, the information processing apparatus is configured such that, when a particular event that is different from operation events made on the operation screen provided by the web server has occurred in the information processing apparatus, the information processing apparatus determines whether or not the web server is waiting for notification of the particular event and if the web server is waiting for notification of the particular event, the information processing apparatus notifies the web server of the particular event.

### BACKGROUND OF THE INVENTION

1. Field of the Invention

The present invention relates to an information processing apparatus that is connected to a web server and is provided with a web browser that displays an operation screen provided by the web server, a control method thereof and a program.

2. Description of the Related Art

It is known that an information processing apparatus such as a PC is connected to a web server on a network and an operation screen provided by the web server is displayed on a web browser installed on the information processing apparatus. In this case, the web browser of the information processing apparatus makes a request for an operation screen to the web server, and a web application on the web server transmits an HTML file for displaying an operation screen on the web browser to the information processing apparatus in response to the request from the information processing apparatus. The web browser of the information processing apparatus analyzes the received HTML file and displays an operation screen based on the description of the received HTML file as a web browser screen. Furthermore, when the user inputs an instruction via the operation screen displayed on the web browser, the web browser notifies the web server of the input instruction. Then, the web application on the web server that has received the notification executes processing in accordance with the input instruction.

Recently, some multi-function peripherals (MFP) that include a scanner and a printer are provided with a web browser as described above. Such an MFP displays an operation screen provided by a web server on the web browser of the MFP in the manner as described above and receives various instructions from the user.

Japanese Patent Laid-Open No. 2007-230244 proposes a technique in which an operation screen for inputting an instruction to use a function of an MFP is provided from a web server to the MFP. Specifically, the user of the MFP inputs an instruction to the MFP via the operation screen displayed on the web browser. Then, the input instruction is notified to the web server by the web browser of the MFP. The web server that has received the notification makes, to the MFP, a request to execute various types of processing in accordance with the content of the instruction input from the user. The MFP that has received the request then executes the requested processing. This eliminates the need to store all menu data for operating the MFP in the MFP, making it easy to make a change to the menu data on the web server.

Japanese Patent Laid-Open No. 2005-165750 proposes a technique in which when the web service functionality provided by an MFP is extended by insertion of a removable storage medium such as a USB memory or SD card, the URLs supported by the MFP are extended by a web page management module. In this case, a web client can use the extended web service functionality of the MFP by accessing the extended URLs.

However, conventional techniques have the following problems. The system as in Japanese Patent Laid-Open No. 2007-230244 in which the web application controls the MFP based on an instruction input via the operation screen displayed on the web browser is required to have a mechanism that transmits event notifications other than web browser operations from the operation screen. Examples of such event notifications include an event notification informing that a USB memory has been inserted and an event notification informing that an original has been set on the platen glass of the MFP. With the existing UI, unlike the web browser, processing is triggered by an event notification as described above and screen transition takes place. Meanwhile, even in a web browser-based UI, it is desirable to provide the same ease of operation depending on the operator, but implementation of such ease of operation requires the above mechanism.

With Japanese Patent Laid-Open No. 2005-165750, the web page management module provided in the MFP monitors insertion of a USB memory, and upon insertion of a USB memory, which is used as a trigger, the web page management module extends URLs to web pages. However, with the mechanism disclosed in Japanese Patent Laid-Open No. 2005-165750, the MFP cannot actively transmit an event notification at a timing required by the web application.

### SUMMARY OF THE INVENTION

The present invention enables realization of an information processing apparatus that, in the case where a particular event that is different from operation events made on an operation screen provided by a web server has occurred, actively transmits a notification of the event to the web server, and a control method thereof.

One aspect of the present invention provides an information processing apparatus that is connected to a web server and is provided with a web browser that communicates with the web server, the information processing apparatus comprising: a detecting unit that detects whether or not a particular event that is different from an operation event made on an operation screen provided by the web server has occurred in the information processing apparatus; a determining unit that determines whether or not the web server is waiting for notification of the particular event; and a notification unit that notifies the web server of the particular event if it is determined by the determining unit that the web server is waiting for notification of the particular event.

Another aspect of the present invention provides a control method of an information processing apparatus that is connected to a web server and is provided with a web browser that communicates with the web server, the method comprising: with a detecting unit, detecting whether or not a particular event that is different from an operation event made on an operation screen provided by the web server has occurred in the information processing apparatus; with a determining unit, determining whether or not the web server is waiting for notification of the particular event; and with a notification unit, notifying the web server of the particular event if it is determined in the determining step that the web server is waiting for notification of the particular event.

Still another aspect of the present invention provides a computer-readable storage medium storing a computer program for causing a computer to execute the steps of the control method of an information processing apparatus.

Further features of the present invention will be apparent from the following description of exemplary embodiments with reference to the attached drawings.

### BRIEF DESCRIPTION OF THE DRAWINGS

FIG. 1 is a diagram showing a configuration of a printing system using an MFP according to a first embodiment of the present invention.

FIG. 2 is a block diagram showing hardware configurations of the MFP and a web server according to the first embodiment.

FIG. 3 is a block diagram showing software configurations of the MFP and the web server according to the first embodiment.

FIG. 4 is a sequence diagram illustrating a series of processing performed when executing a media print function according to the first embodiment.

FIG. 5 is a diagram showing screen transition during media print processing according to the first embodiment.

FIG. 6 is a diagram showing an HTML file transmitted from a web application in the media print processing according to the first embodiment.

FIG. 7 is a diagram showing a web application state transition chart managed by the MFP in the media print processing according to the first embodiment.

FIG. 8 is a flowchart illustrating processing performed when a USB memory insertion event has occurred in the media print processing according to the first embodiment.

FIG. 9 is a sequence diagram illustrating a series of processing performed when executing an FTP transmission function according to a second embodiment of the present invention.

FIG. 10 is a diagram showing screen transition during FTP transmission processing according to the second embodiment.

FIG. 11 is a diagram showing an HTML file transmitted from a web application in the FTP transmission processing according to the second embodiment.

FIG. 12 is a diagram showing a web application state transition chart managed by the MFP in the FTP transmission processing according to the second embodiment.

FIG. 13 is a flowchart illustrating processing performed when an original set event has occurred in the FTP transmission processing according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

Configuration of Printing System

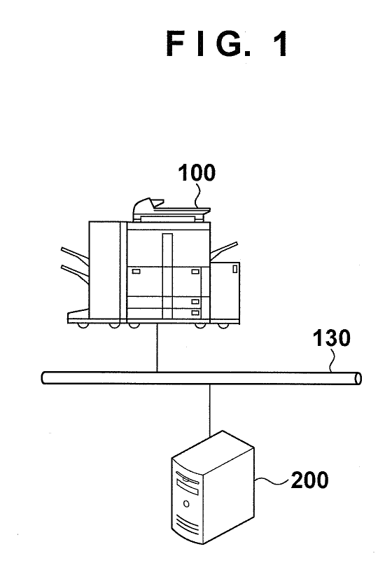

A first embodiment will be described below with reference to FIGS. 1 to 8. An example of the configuration of a printing system using an MFP 100 according to the present embodiment will be described first with reference to FIG. 1. As shown in FIG. 1, in a printing system according to the present embodiment, the MFP 100, an information processing apparatus, and a web server 200, an external apparatus are connected via a network 130. The MFP 100 and the web server 200 are capable of mutual communication via the network 130. A web application runs on the web server 200. A web browser runs on the MFP 100 and executes a web application on the web server 200. In other words, the present embodiment will be described in the context of a printing system in which the MFP 100 executes a web application provided by the web server 200.

Hardware Configuration of Each Apparatus

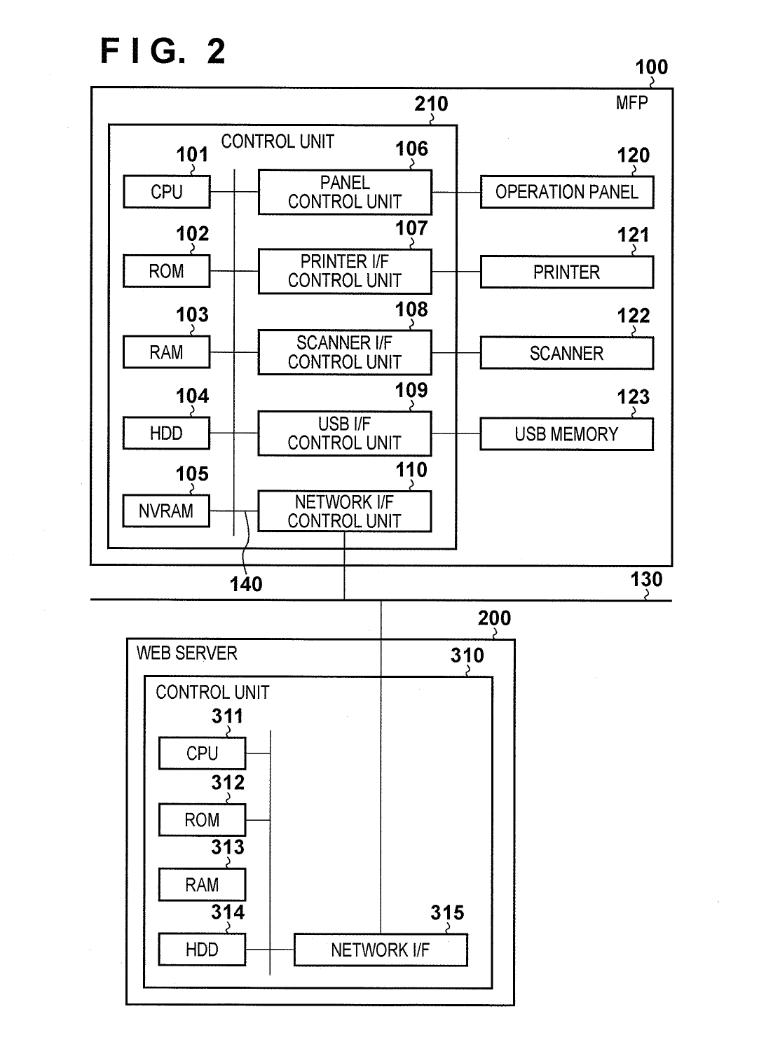

The hardware configurations of the MFP (multi-function peripheral) 100, which is the information processing apparatus of the present embodiment, and the web server 200 will be described next with reference to FIG. 2. The MFP 100 includes a control unit 210, an operation panel 120, a printer 121, a scanner 122 and a removable USB memory 123. The control unit 210 includes a CPU 101, a ROM 102, a RAM 103, a HDD 104, an NVRAM 105, a panel control unit 106, a printer I/F control unit 107, a scanner I/F control unit 108, a USB I/F control unit 109 and a network I/F control unit 110.

The CPU 101 executes a software program of the MFP 100 and performs overall control of the apparatus. The ROM 102 is a read-only memory in which a boot program and fixed parameters for the apparatus and so on are stored. The RAM 103 is a random-access memory that is used for temporary storage of data and the like when the CPU 101 controls the apparatus. The HDD 104 is a hard disk drive that is used for storage of various types of data such as print data. The NVRAM 105 is a non-volatile memory for storing various setting values of the MFP 100.

The panel control unit 106 controls the operation panel 120 so as to display various types of information and input instructions from the user. The printer I/F control unit 107 controls the printer 121. The scanner I/F control unit 108 controls the scanner 122. The USB I/F control unit 109 controls the USB memory 123. The network I/F control unit 110 controls transmission and receipt of data to and from the network 130. The CPU 101, the ROM 102, the RAM 103, the HDD 104, the NVRAM 105, the panel control unit 106, the printer I/F control unit 107, the scanner I/F control unit 108, the USB I/F control unit 109 and the network I/F control unit 110 are connected to a bus 140. The bus 140 is a system bus through which control signals from the CPU 101 and data signals between devices are transmitted and received.

The hardware configuration of the web server 200 will be described next. The web server 200 includes a control unit 310. The control unit 310 includes a CPU 311, a ROM 312, a RAM 313, a HDD 314 and a network I/F 315. The control unit 310 including the CPU 311 performs overall control of the operations of the web server 200. The CPU 311 reads out a control program stored in the ROM 312 and executes various types of control processing. The RAM 313 is used as a temporary storage area such as the main memory and a working area for the CPU 311. The HDD 314 stores image data, various types of programs, and various types of information tables which will be described later. The network I/F 315 connects the control unit 310 (the web server 200) to the network 130. The network I/F 315 transmits and receives various types of information to and from other devices on the network 130.

Software Configuration of Each Apparatus

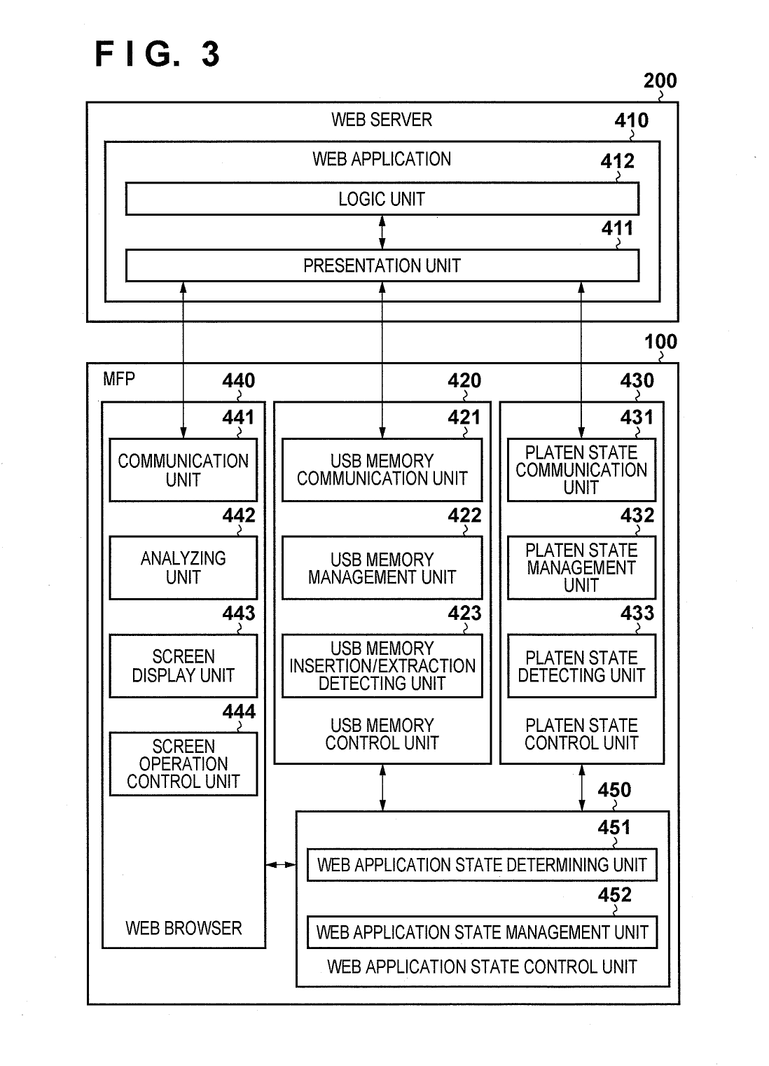

Examples of software configurations of the MFP 100 and the web server 200 will be described next with reference to FIG. 3. Functional units shown in FIG. 3 are implemented by the CPU 101 of the MFP 100 and the CPU 311 of the web server 200 executing a control program. The MFP 100 includes a web browser 440, a USB memory control unit 420, a platen glass state control unit 430 and a web application state control unit 450.

The web browser 440 includes a communication unit 441, an analyzing unit 442, a screen display unit 443 and a screen operation control unit 444. The communication unit 441 communicates with a presentation unit 411 of a web application 410 in accordance with the HTTP protocol. More specifically, the communication unit 441 makes a request for screen information of the operation screen to be displayed on the web browser to the web application 410. Also, the communication unit 441 receives a response (result of processing) to the request, transmitted from the web application 410. The analyzing unit 442 analyzes the response received from the web application 410. The response includes HTML data (screen information). The HTML data includes a description indicating the content of an operation screen to be displayed on the web browser 440 and HTML data indicating the state of the web application 410. The screen display unit 443 displays an operation screen on an operation panel 120 based on the result of analysis of the HTML data. The screen operation control unit 444 controls a user interface provided in the web browser 440. As the user interface control, processing such as enabling and disabling of an input button, or permitting and prohibiting of display (of an input button?) is carried out.

The USB memory control unit 420 includes a USB memory communication unit 421, a USB memory management unit 422 and a USB memory insertion/extraction detecting unit 423. The USB memory communication unit 421 functions as a web service provider and responds to a USB memory-related HTTP request from the web application 410. The USB memory insertion/extraction detecting unit 423 detects the insertion/extraction state of a USB memory with respect to the MFP 100. The USB memory management unit 422 manages the USB memory insertion/extraction state, notifies a USB memory insertion/extraction state event, and responds to a query for the USB memory insertion/extraction state. Also, the USB memory management unit 422 manages image file information in the USB memory and responds to a query for the image file information in the USB memory.

The platen glass state control unit 430 includes a platen glass state communication unit 431, a platen glass state management unit 432 and a platen glass state detecting unit 433. The platen glass state communication unit 431 functions as a web service provider and responds to a platen glass state-related HTTP request from the web application 410. The platen glass state detecting unit 433 detects the state of the platen glass such as a state in which an original has been set (placed) on the platen glass or a state in which the original has been removed. The platen glass state management unit 432 manages the state of the platen glass, notifies a platen glass state change event, and responds to a query for the state of the platen glass. In the MFP 100, the USB memory insertion/extraction detecting unit 423 and the platen glass state detecting unit 433 detect whether or not a particular event different from the operation events made on the operation screen provided by the web application 410 has occurred.

The web application state control unit 450 includes a web application state determining unit 451 and a web application state management unit 452. The web application state determining unit 451 determines the web application state by using the HTML data indicating the state of the web application 410 and included in the HTML notified from the web application 410. The HTML data is notified from the web browser 440 to the web application state control unit 450. The web application state management unit 452 manages the web application state determined by the web application state determining unit 451. Specifically, depending on the web application state, the web application state management unit 452 processes the events from the USB memory control unit 420 and the platen glass state control unit 430 or queries the USB memory control unit 420 and the platen glass state control unit 430 about the state.

Media Print Processing

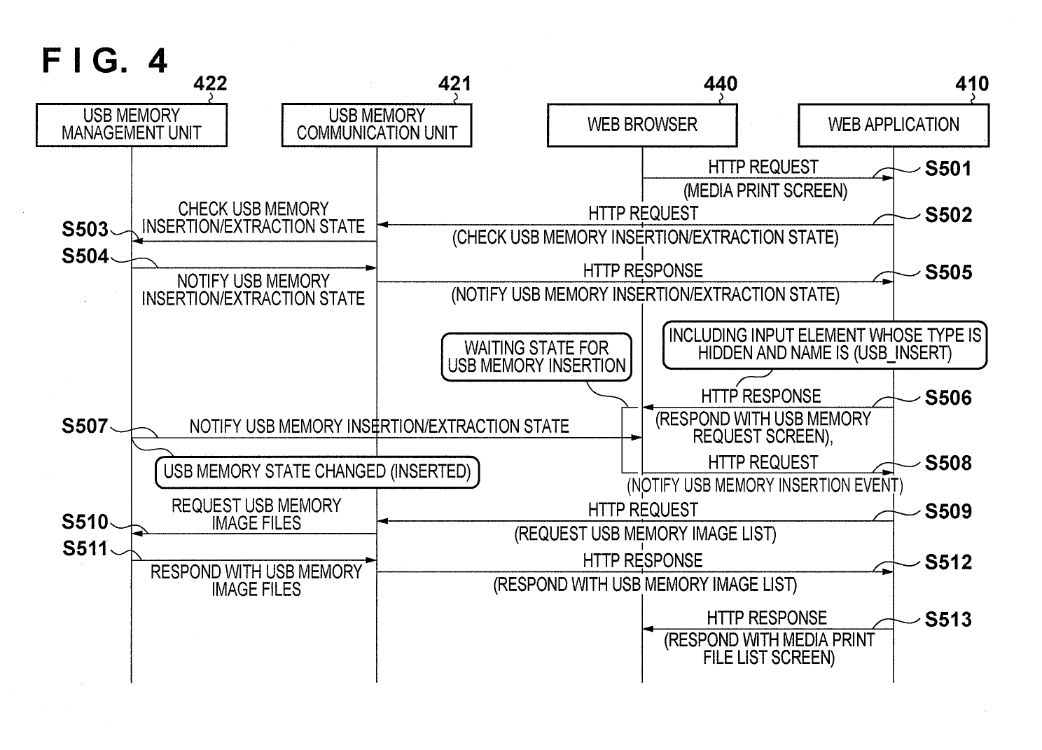

A process sequence performed when executing media print according to the present embodiment will be described next with reference to FIG. 4. The media print processing refers to processing for executing printing by reading out an image file from a storage medium inserted in the MFP 100. In the present embodiment, the media print processing will be described by way of example. However, the present invention is not limited thereto, and the processing may be any processing as long as it involves insertion of a storage medium into the MFP 100, or in other words, processing that generates an event (in this example, insertion of a storage medium (USB memory)) other than operation events made via the operation screen provided by the web application 410.

First, the web browser 440 of the MFP 100 is activated by the user, and a media print function is selected. When the media print function has been selected, in step S501, the web browser 440 transmits an HTTP request requesting screen information of a media print screen to the web application 410. In step S502, the web application 410 that has received the HTTP request transmits an HTTP request querying about the insertion/extraction state of a USB memory to the USB memory communication unit 421. In step S503, the USB memory communication unit 421 that has received the HTTP request queries the USB memory management unit 422 about the insertion/extraction state of a USB memory. Upon receiving the query, the USB memory management unit 422 notifies the USB memory communication unit 421 of the insertion/extraction state of a USB memory in step S504. Upon receiving the notification, the USB memory communication unit 421 transmits an HTTP response including the insertion/extraction state of a USB memory to the web application 410 in step 5505.

In step S505, the web application 410 detects the insertion/extraction state of a USB memory. If it is detected that a USB memory has not been inserted, the web application 410 transmits to the web browser 440 an HTTP response embedded with an html tag that is a hidden type input element and in which name=“usb_insert” is written in step S506. The HTTP response also includes information regarding an HTML image for displaying a message that prompts the user to insert a USB memory.

Upon receiving the HTTP response including an html tag that is a hidden type input element and in which name=“usb_insert” is written, the web browser 440 determines that the web application 410 is waiting for a USB memory insertion event. At this time, if the USB memory management unit 422 detects that a USB memory has been inserted, the USB memory management unit 422 notifies the web browser 440 of the event in step S507. Upon receiving the notification indicating that a USB memory has been inserted, the web browser 440 transmits an HTTP request to the web application 410 in step S508. The HTTP request includes information including “usb_insert” which is an input element written in the html tag and indicating that a USB memory insertion event has occurred.

Next, upon receiving the HTTP request, the web application 410 transmits an HTTP request requesting a USB memory image list to the USB memory communication unit 421 in step S509. Subsequently, upon receiving the HTTP request, the USB memory communication unit 421 makes a request for USB memory image files to the USB memory management unit 422 in step S510. Upon receiving the request, the USB memory management unit 422 notifies the USB memory communication unit 421 of the USB memory image files in step S511. Upon receiving the notification, the USB memory communication unit 421 transmits an HTTP response notifying the USB memory image list in step S512. Furthermore, upon receiving the HTTP response, the web application 410 generates a media print file list screen and transmits an HTTP response including the media print file list screen to the web browser 440 in step S513.

Example Screens

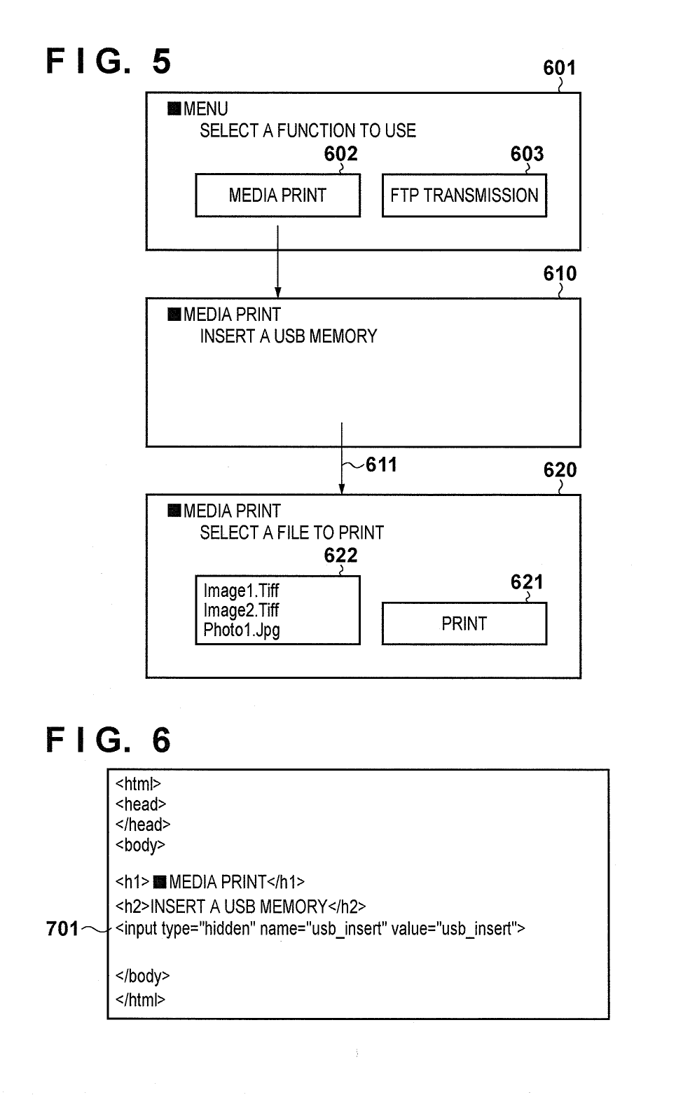

An example of screen transition according to the present embodiment will be described next with reference to FIG. 5. As shown in FIG. 5, processing is performed in the order of transition of screens: a menu screen 601, a media print/USB memory inserting request screen 610 and a media print/print file selecting screen 620. Each screen is displayed on the web browser 440, and the screens transition with user operations. The menu screen 601 is a screen for prompting the user to select one of the functions of the MFP 100 so as to use the function. If a media print button 602 in the screen is pressed, the screen transitions to a media print screen. If an FTP transmission button 603 is pressed, the screen transitions to an FTP transmission screen.

The media print/USB memory inserting request screen 610 is a screen displayed if the media print button 602 in the menu screen 601 is pressed by the user to use the media print function when a USB memory has not been inserted into the MFP 100. This screen prompts the user to insert a USB memory. Transition from the media print/USB memory inserting request screen 610 to the media print/print file selecting screen 620 as indicated by an arrow 611 occurs when a USB memory is inserted into the MFP 100. Furthermore, the media print/print file selecting screen 620 is also displayed if the media print button 602 in the menu screen 601 is pressed when a USB memory has been inserted into the MFP 100. In this screen, an image file list of image files stored in the USB memory is displayed in a field 622. By the user selecting any of the image files in the image file list displayed in the field 622 and pressing a print button 621, the selected image file can be printed.

HTTP Response

An HTTP response including an html tag that is a hidden type input element and in which name=“usb_insert” is written according to the present embodiment will be described next with reference to FIG. 6. Specifically, the HTTP response is screen information transmitted to the web browser 440 by the web application 410 in order to display the media print/USB memory inserting request screen 610 shown in FIG. 5. The HTTP response is transmitted in step S506 of FIG. 4. Reference numeral 701 indicates an input element in which input type=“hidden” and name=“usb_insert” are written. The web application 410 thus adds information indicating that the web application 410 is waiting for notification of a particular event to the screen information that is to be transmitted with the HTTP response.

State Transition of Web Application

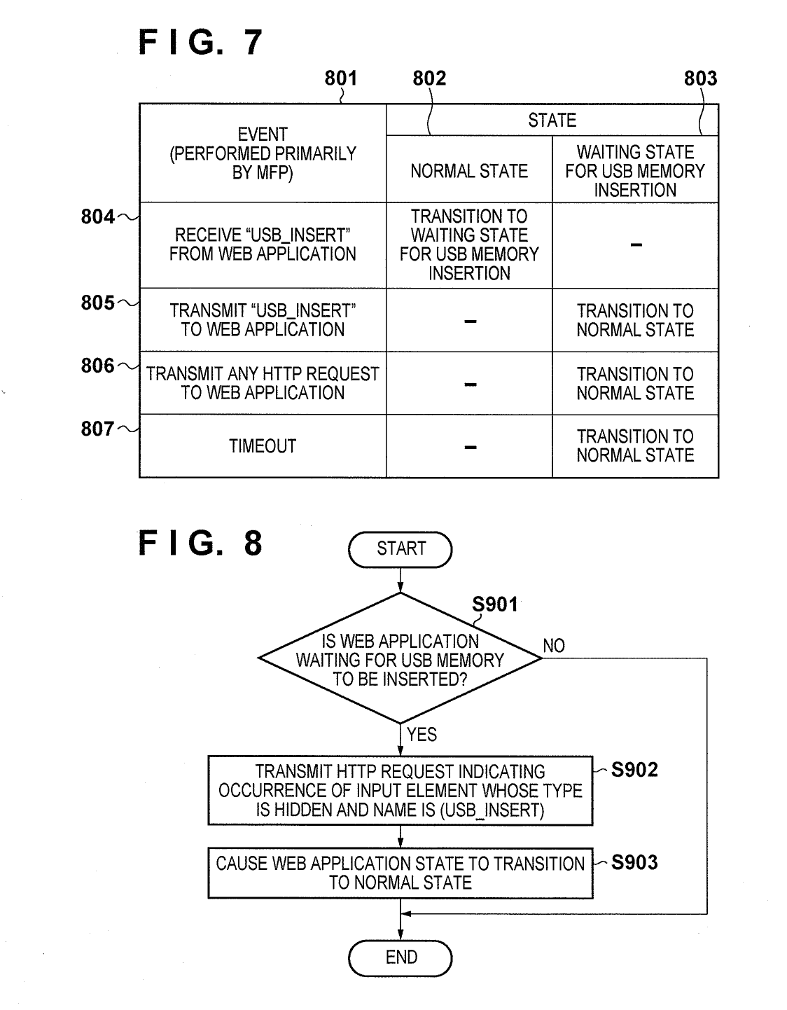

A state transition chart of the web application 410 managed by the MFP 100 of the present embodiment will be described next with reference to FIG. 7. To begin with, the state of the web application 410 includes a normal state 802 and a waiting state 803 for insertion of a USB memory. Four events 804 to 807 are defined. If an event 804 occurs in which an input element in which input type=“hidden” and name=“usb_insert” are written is received from the web application 410, the web application 410 transitions to the waiting state for USB memory insertion if the web application 410 is in the normal state.

Other events include: an event 805 in which the web browser 440 transmits an occurrence of “usb_insert” to the web application 410; an event 806 in which any HTTP request is transmitted to the web application 410; and a timeout event 807 that indicates that a predetermined period of time has elapsed since the web application 410 transitioned to the waiting state for USB memory insertion. If the web application 410 is in the waiting state for USB memory insertion at the time of the occurrence of any of these events, the web application 410 transitions to the normal state, or in other words, releases the waiting state for notification of a particular event.

Processing Flow Performed When USB Memory Insertion Event Has Occurred

A processing flow performed when a USB memory insertion event has occurred in the MFP 100 of the present embodiment will be described next with reference to FIG. 8. Overall control of the processing described below is performed by the CPU 101 of the control unit 210. When a USB memory is inserted into the MFP 100, the USB memory insertion/extraction detecting unit 423 detects the insertion of the USB memory and notifies the web application state control unit 450 of that fact.

First, in step S901, the web application state determining unit 451 determines whether or not the web application state managed by the MFP 100 is the waiting state for a USB memory to be inserted. At this time, if it is determined that the web application state is not the waiting state for a USB memory to be inserted, the processing ends without any operations. If, on the other hand, it is determined that the web application state is the waiting state for a USB memory to be inserted, the processing advances to step S902, where the web browser 440 transmits an HTTP request indicating the occurrence of an input element in which input type=“hidden” and name=“usb_insert” are written to the web application 410. Then, in step S903, the web application state control unit 450 causes the web application state managed by the MFP 100 to transition to the normal state, and the processing ends.

As described above, when the information processing apparatus of the present embodiment detects insertion of a USB memory while the web application 410 provided by the web server 200 is being executed, the information processing apparatus notifies the web server 200 of an event indicating that a USB memory has been inserted. The information processing apparatus of the present embodiment determines the state of the web application 410, and if the web application 410 is waiting for notification of a USB memory insertion event, the information processing apparatus notifies the event. With this configuration, even if a USB memory insertion event that is different from operation events made on the operation screen provided by the web application occurs while the web application is being executed, the information processing apparatus of the present embodiment can actively transmit the event to the web server. The present embodiment has been described taking a USB memory insertion event as an example, but the present embodiment is not intended to be limited to this event, and any event can be used as long as it involves insertion of a storage medium that is insertable into and removable from the information processing apparatus. An instance that requires notification of an event to the web application 410 as described above can be a case where the web application 410 executes processing using an image file stored in the storage medium.

### Second Embodiment

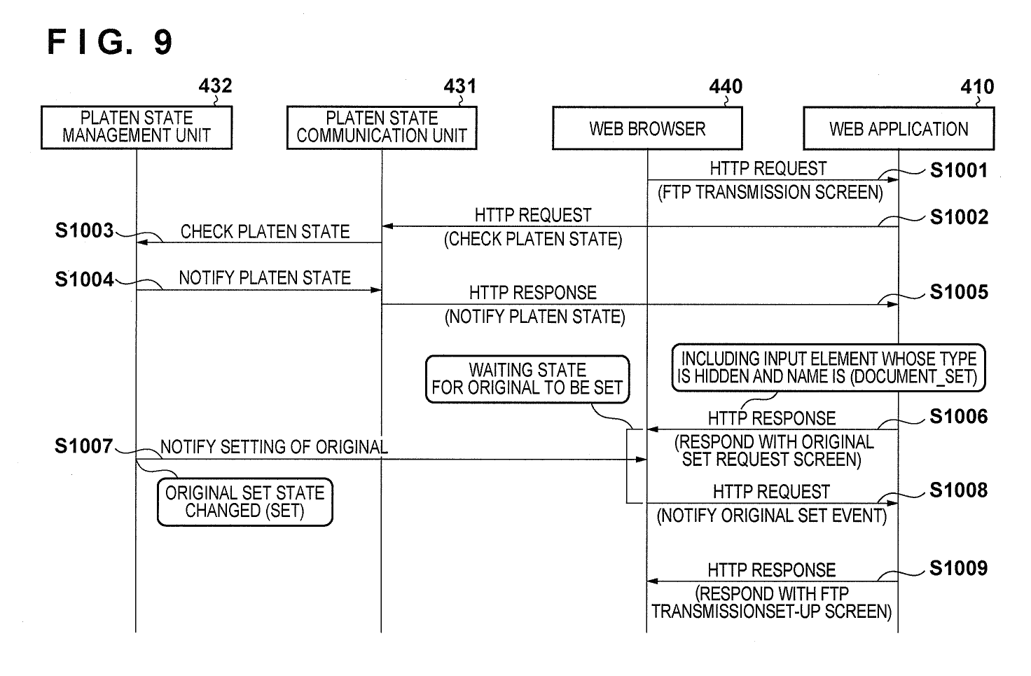

A second embodiment will be described below with reference to FIGS. 9 to 13. In the present embodiment, processing performed when FTP transmission processing has been selected in the web browser 440 will be described. A description of the same constituent elements and technique as those of the first embodiment described above is omitted here. Also, in the present embodiment, FTP transmission processing will be described by way of example, but the present invention is not limited thereto, and the processing may be any processing as long as it involves placing an original on the platen glass, or in other words, processing that generates an event (in this example, placing an original on the platen glass) other than operation events via the operation screen provided by the web application 410.

FTP Transmission Processing

A process sequence of FTP transmission processing according to the present embodiment will be described next with reference to FIG. 9. First, the web browser 440 of the MFP 100 is activated by the user and an FTP transmission function is selected. When the FTP transmission function has been selected, in step S1001, the web browser 440 transmits an HTTP request requesting an FTP transmission screen to the web application 410. In step S1002, the web application 410 that has received the request transmits an HTTP request querying about the state of the platen glass to the platen glass state communication unit 431.

In step S1003, the platen glass state communication unit 431 that has received the HTTP request queries the platen glass state management unit 432 about the state of the platen glass. Upon receiving the query, the platen glass state management unit 432 notifies the platen glass state communication unit 431 of the state of the platen glass in step S1004. Upon receiving the notification, the platen glass state communication unit 431 transmits an HTTP response indicating the state of the platen glass to the web application 410 in step S1005.

The web application 410 detects the state of the platen glass in step S1005. If an original is not set on the platen glass, the web application 410 transmits an HTTP response embedded with an html tag that is a hidden type input element and in which name=“document_set” is written to the web browser 440 in step S1006. The HTTP response also includes information regarding an HTML image for displaying a message that prompts the user to set an original on the platen glass.

When the web browser 440 receives the HTTP response including an html tag that is a hidden type input element and in which name=“document_set” is written, it is determined that the web application is waiting for an original to be set. At this time, if it is detected that an original has been set, the platen glass state management unit 432 notifies the web browser 440 of the fact that an original has been set in step S1007. Upon receiving the notification that an original has been set, the web browser 440 transmits an HTTP request to the web application 410 in step S1008. The HTTP request includes an input element in which input type=“hidden” and name=“document_set” are written, which indicates that an original set event has occurred. Subsequently, in step S1009, upon receiving the HTTP request, the web application 410 generates an FTP transmission set-up screen and transmits an HTTP response including the FTP transmission set-up screen to the web browser 440.

Example Screens

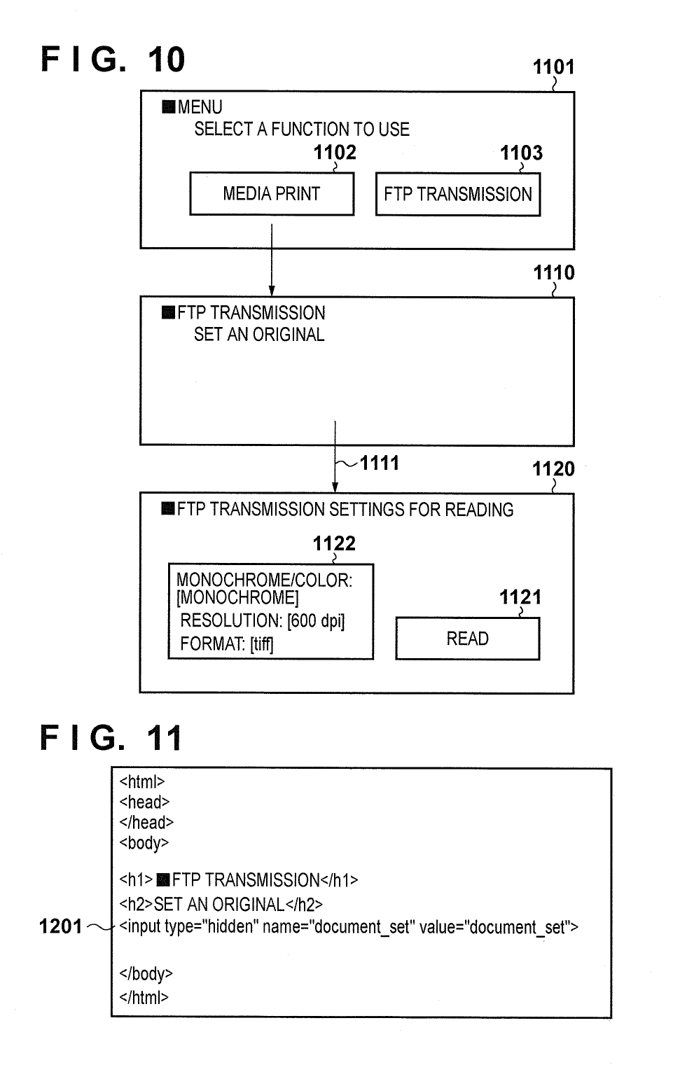

An example of screen transition according to the present embodiment will be described next with reference to FIG. 10. As shown in FIG. 10, processing is performed in the order of transition of screens: a menu screen 1101, an FTP transmission/original set request screen 1110 and an FTP transmission/reading set-up screen 1120. Each screen is displayed on the web browser 440, and the screens transition with user operations. The menu screen 1101 is a screen for prompting the user to select one of the functions of the MFP 100 so as to use the function. If a media print button 1102 in the screen is pressed, the screen transitions to a media print screen. If an FTP transmission button 1103 is pressed, the screen transitions to an FTP transmission screen.

The FTP transmission/original set request screen 1110 is a screen displayed if the FTP transmission button 1103 in the menu screen 1101 is pressed by the user to use the FTP transmission function when an original is not set on the platen glass of the MFP 100. This screen prompts the user to set an original on the platen glass.

The FTP transmission/reading set-up screen 1120 is displayed if the user sets an original on the platen glass of the MFP 100 while the FTP transmission/original set request screen 1110 is being displayed. The FTP transmission/reading set-up screen 1120 is also displayed if the FTP transmission button 1103 in the menu screen 1101 is pressed when an original has been set on the platen glass of the MFP 100. In this screen, settings for reading a file for FTP transmission are displayed in 1122. By the user changing the settings for reading a file for FTP transmission displayed in 1122 to desired settings and pressing a read button 1121, FTP transmission of an image file can be executed using the selected settings.

HTTP Response

An HTTP response including an html tag that is a hidden type input element and in which name=“document_set” is written according to the present embodiment will be described next with reference to FIG. 11. Specifically, the HTTP response is screen information transmitted to the web browser 440 by the web application 410 in order to display the FTP transmission/original set request screen 1110 shown in FIG. 10. The HTTP response is transmitted in step S1006 of FIG. 9. Reference numeral 1201 indicates an input element in which input type=“hidden” and name=“document_set” are written. The web application 410 thus adds information indicating that the web application 410 is waiting for notification of a particular event to the screen information that is to be transmitted with the HTTP response.

State Transition of Web Application

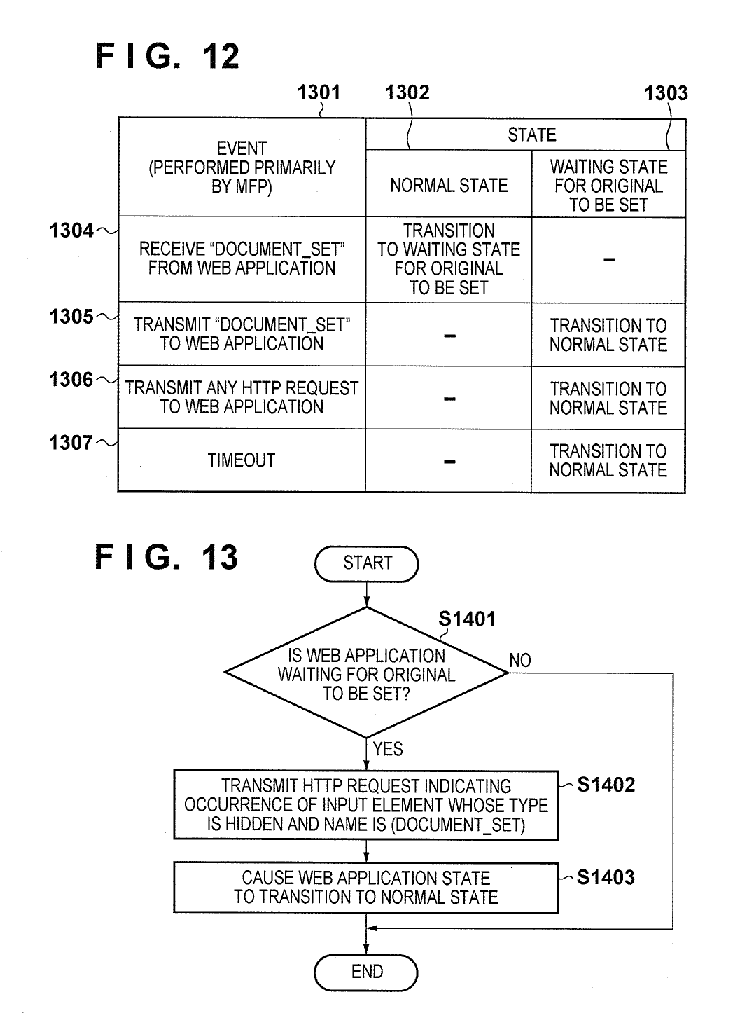

A state transition chart of the web application 410 managed by the MFP 100 of the present embodiment will be described next with reference to FIG. 12. To begin with, the state of the web application 410 includes a normal state 1302 and a waiting state 1303 for an original to be set. Four events 1304 to 1307 are defined. If an event 1304 occurs in which an input element in which input type=“hidden” and name=“document_set” are written is received from the web application 410, the web application 410 transitions to the waiting state for an original to be set if the web application 410 is in the normal state.

Other events include: an event 1305 in which the web browser 440 transmits an occurrence of “document_set” to the web application 410; an event 1306 in which any HTTP request is transmitted to the web application 410; and a timeout event 1307 that indicates that a predetermined period of time has elapsed since the web application 410 transitioned to the waiting state for an original to be set. If the web application 410 is in the waiting state for an original to be set at the time of the occurrence of any of these events, the web application 410 transitions to the normal state, or in other words, releases the waiting state for notification of a particular event.

Processing Flow Performed When Original Set Event Has Occurred

A processing flow performed when an original set event has occurred in the MFP 100 of the present embodiment will be described next with reference to FIG. 13. Overall control of the processing described below is performed by the CPU 101 of the control unit 210. When an original has been set, the platen glass state detecting unit 433 detects setting of the original and notifies the web application state control unit 450 of that fact.

First, in step S1401, the web application state determining unit 451 determines whether or not the web application state managed by the MFP 100 is the waiting state for an original to be set. At this time, if it is determined that the web application state is not the waiting state for an original to be set, the processing ends without any operations. If, on the other hand, it is determined that the web application state is the waiting state for an original to be set, the processing advances to step S1402, where the web browser 440 transmits an HTTP request indicating the occurrence of an input element in which input type=“hidden” and name=“document_set” are written to the web application 410. Then, in step S1403, the web application state control unit 450 causes the web application state managed by the MFP 100 to transition to the normal state, and the processing ends.

As described above, when the information processing apparatus of the present embodiment detects that an original has been set on the platen glass while the web application 410 provided by the web server 200 is being executed, the information processing apparatus notifies the web server 200 of an event indicating that an original has been set. The information processing apparatus of the present embodiment determines the state of the web application 410, and if the web application 410 is waiting for notification of an original set event, the information processing apparatus notifies the event. With this configuration, even if an original set event that is different from operation events made on the operation screen provided by the web application occurs while the web application is being executed, the information processing apparatus of the present embodiment can actively transmit the event to the web server. The present embodiment has been described taking an original set event as an example, but an instance that requires notification of such an event to the web application 410 as described above can be a case where the web application 410 executes processing for reading an original.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-279872 filed on Dec. 15, 2010, which is hereby incorporated by reference herein in its entirety.

What is claimed is:

1. An information processing apparatus that is connected to a web server and is provided with a web browser that communicates with the web server, the information processing apparatus comprising:
a detecting unit that detects whether or not a particular event that is different from an operation event made on an operation screen provided by the web server has occurred in the information processing apparatus;
a determining unit that determines whether or not the web server is waiting for notification of the particular event; and
a notification unit that notifies the web server of the particular event if it is determined by the determining unit that the web server is waiting for notification of the particular event.

2. The information processing apparatus according to claim 1, further comprising a management unit that manages whether or not the web server is waiting for notification of the particular event based on information included in screen information transmitted from the web server, the screen information being screen information for generating an operation screen provided by the web server,
wherein the determining unit determines whether or not the web server is waiting for notification of the particular event in accordance with the information managed by the management unit.

3. The information processing apparatus according to claim 2,
wherein in a case where the web server is waiting for notification of the particular event, the management unit releases the waiting state for notification of the particular event if a predetermined period of time has elapsed since the web server transitioned to the waiting state for notification of the particular event, if the particular event is notified to the web server, or if a request is transmitted from the information processing apparatus to the web server.

4. The information processing apparatus according to claim 2,
wherein the particular event is an event in which a storage medium insertable into and removable from the information processing apparatus is inserted, and
the web server adds information indicating that the web server is waiting for notification of the particular event to the screen information in a case where processing using an image file stored in the storage medium is executed.

5. The information processing apparatus according to claim 2,
wherein the particular event is an event in which an original is placed on a platen glass, and
the web server adds information indicating that the web server is waiting for notification of the particular event to the screen information in a case where processing for reading the original is executed.

6. A control method of an information processing apparatus that is connected to a web server and is provided with a web browser that communicates with the web server, the method comprising:
with a detecting unit, detecting whether or not a particular event that is different from an operation event made on an operation screen provided by the web server has occurred in the information processing apparatus;
with a determining unit, determining whether or not the web server is waiting for notification of the particular event; and
with a notification unit, notifying the web server of the particular event if it is determined in the determining step that the web server is waiting for notification of the particular event.

7. A computer-readable storage medium storing a computer program for causing a computer to execute the steps of the control method of an information processing apparatus according to claim 6.
